(19) United States
(12) Patent Application Publication
(10) Pub. No.: US 2026/0100871 A1
(43) Pub. Date: Apr. 9, 2026

(54) DECODER CIRCUIT, CORRESPONDING RECEIVER AND TRANSMISSION SYSTEM

(71) Applicant: STMicroelectronics International NV, Geneva (CH)

(72) Inventors: Carlo Porcaro, Reggio Calabria (IT); Daniele Colonna, Leonforte (IT)

(21) Appl. No.: 19/319,951

(22) Filed: Sep. 5, 2025

(30) Foreign Application Priority Data
Oct. 9, 2024 (IT) 102024000022482

(51) Int. Cl. H04L 27/14

(52) U.S. Cl. CPC H04L 27/14

(57) ABSTRACT

A decoder receives, from a demodulator of FSK modulated signals, a sequence of demodulated symbols having level transitions between adjacent demodulated symbols and at least a part of the demodulated symbols having level transitions between adjacent signaling elements therein. A sample counter samples the sequence of demodulated symbols. A comparator performs comparison of the samples with at least one reference threshold and the results for at least three adjacent signaling elements in the decoded symbols are stored in a buffer. Logic circuitry asserts an error-in-transmission signal or an end-of-transmission signal in response to an isolated or persisting absence of level transitions detected over a reference period of time. Sampling point drift correction circuitry coupled to the buffer circuit varies the end-of-count value of the sample counter in response to an accumulated sampling point error reaching a drift reference threshold.

### CROSS-REFERENCE TO RELATED APPLICATIONS

This application claims priority to Italian Application No. 102024000022482, filed on Oct. 9, 2024, which application is hereby incorporated herein by reference.

### TECHNICAL FIELD

The description relates to receiving digital signals.

Aspects of the present description can be applied, by way of non-limiting example, to signals transmitted using frequency shift keying (FSK) techniques.

For instance, solutions as described herein can be advantageously applied in providing a hardware FSK decoder compliant with a Qi protocol. Reference to such interface standard and/or possible use for wireless power transfer using inductive charging is otherwise merely by way of non-limiting example.

### BACKGROUND

FIG. 1 of the annexed figures is a block diagram of a communication system including a transmitter TX and a receiver RX.

By way of non-limiting example, reference is made herein to a wireless power transfer system suited for use in inductive charging of devices such as smartphones, smartwatches, tablets and the like.

Communication between the transmitter TX and the receiver RX is via an inductive coupling represented here as a transformer T having a primary winding W1 in the transmitter TX which transmits power to a secondary winding W2 in the receiver RX.

In the transmitter TX, the primary winding W1 of the transformer T is driven by a power conversion unit PC coupled to a communication and control unit TCU. Operation of the power conversion unit PC and the communication and control unit TCU is supervised by a transmitter system unit SU.

In the receiver RX, the secondary winding W2 of the transformer T drives a power pick-up unit PU coupled to a load L (a battery to be charged, for instance). Operation of the power pick-up unit PU that supplies the load Lis supervised by a communication and control unit RCU.

The load L is represented here as part of the receiver RX essentially for simplicity of explanation. The load (a battery, for example) may in fact be a distinct element from the embodiments that is intended to be coupled thereto only by an end user (possibly just temporarily, to perform a charging operation, for instance).

The discussion herein is primarily concerned with (data) transmission from the transmitter TX to the receiver RX, which in the case exemplified herein takes place using Frequency Shift Keying (FSK) modulation.

In a system as exemplified herein, data transmission can also take place in the opposite direction, namely from the receiver RX to the transmitter TX, using Amplitude Shift Keying (ASK) modulation, for instance.

For the purposes of this description (and, possibly the claims appended thereto), the designation “transmitter” and the designation “receiver” will apply to the blocks TX and RX having regard to their roles in transmitting power and data, namely with the transmitter TX sending data to the receiver RX using frequency shift keying, with the transmitter TX modulating the frequency of a signal that is transferred from the transmitter TX to the receiver RX via the transformer T.

In the exemplary case of FSK modulation considered here, the transmitter TX changes its operating frequency between a current operating frequency and at least one alternate frequency in the modulated state.

The difference between these frequencies can be selected based on parameters that are determined during an initial identification and configuration phase of the wireless power connection.

Exemplary of those parameters are: polarity, which determines whether the difference between the frequencies involved is positive or negative; and depth, which determines the magnitude of the difference between these frequencies in Hertz (Hz).

In such a system, the transmitter TX can be configured to modulate data bits to the carrier wave according to a differential bi-phase encoding scheme, also referred to as differential Manchester code (DMC) or biphase mark code (BMC).

FIGS. 2A, 2B, and 2C represent against a common abscissa time scale t possible time behaviors (waveforms) of, from top to bottom: a base clock signal (FIG. 2A); a data signal to be transmitted (bits as represented by logical “1s” and “0s”—FIG. 2B); and a BMC encoded signal (FIG. 2C).

In a BMC encoded signal as illustrated herein, logical “1s” are encoded as symbols including a high-to-low, 1-to-0 level transition within each symbol or a low-to-high, 0-to-1 level transition within each symbol.

Conversely, logical “0s” are encoded as symbols that do not include level transitions within each symbol: high-to-low or low-to-high level transitions occur however between subsequent symbols that encode sequences of logical 0s in the data signal to be transmitted.

While sometimes used as a synonym of bit, a symbol is a waveform, a state, or a significant condition of a communication channel over a fixed period of time. Each symbol may thus encode one or several binary digits (bits) and the data may also be represented by the transitions between symbols or a sequence of many symbols.

For instance, in the—merely exemplary—case considered herein (wireless power transfer using inductive charging) a transmitter TX can use a differential bi-phase encoding scheme to modulate data bits in the power signal by aligning each data bit to 512 cycles of the power signal frequency (this is 127.77 kHz in the Qi standard, for instance).

As exemplified in FIG. 3, the transmitter TX can thus encode:
logical “1” bits using two transitions in the FSK signal frequency, with a first transition occurring at the start of the symbol and a second transition occurring at 256 cycles into the symbol (that is, at half the bit duration); and
“0” bits using a single transition in the signal frequency at the start of the symbol.

If such an encoding scheme is applied to FSK transmission, a frequency transition will occur at half the duration of the FSK carrier cycles for one symbol.

Thus, if the FSK carrier frequency changes at this point (at the 256th cycle), then a logical “1” is being sent and if during the entire symbol duration of 512 cycles no (significant) frequency change occurs, then a logical “0” is being sent.

In both instances, the frequency of the received FSK signal will change at the 512th cycle, that is at the end of each symbol (here at the end of a one-bit data transfer).

As noted, a wireless inductive charging system including a (power) transmitter TX using a DMC (or BMC) differential bi-phase encoding scheme to modulate data bits in a power signal is mentioned primarily by way of example.

The possible examples of use of FSK modulation discussed so far are otherwise conventional in the art and a more detailed description is not provided herein for brevity.

In fact, in their more general aspects, solutions as described herein can be applied to various types of encoding schemes that have inter-symbol variations (that is, variations occurring between adjacent symbols) and, possibly, intra-symbol variations (that is, variations occurring between signaling elements, SE within an individual symbol: see, by way of example, the high-to-low transitions in the symbols that encode digital “1s” in Manchester/BMC encoding as represented in FIG. 2C).

Again, reference to FSK modulation is thus primarily by way of example.

Reference to FSK modulation otherwise facilitates understanding advantageous aspects of solutions described herein that address certain issues likely to arise in connection with FSK modulation.

Modulation schemes to which solutions as described herein can be applied in their more general aspects may be both of the non-return to zero (NRZ) or of the return to zero (RZ) type.

Non-return to zero (NRZ) modulation as exemplified in FIG. 4 involves (inter-symbol) variations between two values which represent binary information (for instance, between two frequency values F1→1, F2→0, if applied to FSK transmission).

Return to zero (RZ) modulation as exemplified in FIG. 5 involves variations among three values.

If applied to FSK transmission, the third value (referred to as “rest” frequency, FR) is the frequency value of the unmodulated carrier. Every second half of a bit transmitted with RZ is at the rest frequency value, while the first half is either one of two other values, which represent binary information (e.g. F1&FR→1. F2&FR→0).

In a common approach in the art, demodulation is performed via hardware (HW) while decoding of the demodulated transmission is usually performed via firmware (FW).

This is advantageous in terms of flexibility (possibility of carrying out different checks), but is hardly compatible with lowering power consumption and reducing costs.

Reducing power consumption may rely on various approaches: clock gating, power gating, decreasing the clock frequency and using energy-efficient CPUs (Arm® Cortex®-Mo+, for instance) may be exemplary of these approaches.

These approaches may also prove beneficial in terms of occupation area (for instance ≈30 kG (kiloGates) vs. ≈75 kG w/o Floating Point Unit or ˜125 kG with Floating Point Unit U, considering a clock of few tens of MHz).

In addition to decoding the demodulated transmission, a central processing unit (CPU) in a receiver may also be involved in executing a state machine that controls the charging protocol: consequently, these approaches may lead to a bottleneck in terms of computational load.

That issue may otherwise arise in all those applications where a CPU is called to carry out further tasks (handling other IPs, for instance) in addition to managing decoding of the demodulated transmission: wireless charging is thus just a possible example of an area where these issues may arise.

### SUMMARY

An object of one or more embodiments is to contribute in addressing the issues discussed in the foregoing.

According to one or more embodiments, such an object can be achieved via a decoder circuit having the features set forth in the claims that follow.

One or more embodiments relate to a corresponding receiver (demodulator plus decoder) as well as to a corresponding transmission system.

A wireless charger for use, for instance, in smartphones, smartwatches, tablets or the like may be exemplary of a device that may include such a transmission system.

The claims are an integral part of the disclosure provided herein in respect of the embodiments.

### BRIEF DESCRIPTION OF THE DRAWINGS

One or more embodiments will now be described, by way of example only, with reference to the annexed figures, wherein:

FIG. 1 is a block diagram of a communication system including a transmitter and a receiver;

FIGS. 2A, 2B, and 2C are timing diagrams of time behaviors of, respectively, a base clock signal, a data signal to be transmitted, and a BMC encoded signal;

FIG. 3 illustrates differential bi-phase encoding;

FIG. 4 illustrates non-return to zero modulation;

FIG. 5 illustrates return to zero modulation;

FIG. 6 is a high-level block diagram illustrative of a possible context of use of solutions as described herein;

FIG. 7 is a high-level block diagram of a demodulator suited to be included in a receiver circuit according to solutions as described herein;

FIG. 8 is a high-level block diagram of a decoder circuit according to solutions as described herein;

FIG. 9 illustrates a possible time behavior of a signal that may occur in solutions as described herein;

FIGS. 10A and 10B plus FIGS. 11A and 11B illustrate possible approaches in end-of-packet/error detection in solutions as described herein;

FIG. 12 is a flow-chart illustrative of end-of-packet/error detection in solutions as described herein;

FIG. 13 is a functional diagram illustrative of possible implementation details of solutions as described herein;

FIG. 14 is a block diagram illustrative of possible sampling counter drift error compensation in solutions as described herein;

FIGS. 15A, 15B, and 15C illustrate a possible approach for drift control errors in solutions as described herein;

FIG. 16 exemplifies the possible application of solutions as described herein to Return to Zero (RZ) signals;

FIG. 17 exemplifies the possible application of solutions as described herein to No-Return to Zero (NRZ) signals; and

FIG. 18 is a flow-chart of a possible approach in dynamic drift compensation in solutions as described herein.

The figures are drawn to clearly illustrate the relevant aspects of the embodiments and are not necessarily drawn to scale.

The edges of features drawn in the figures do not necessarily indicate the termination of the extent of the feature.

### DETAILED DESCRIPTION OF ILLUSTRATIVE EMBODIMENTS

In the ensuing description, one or more specific details are illustrated aimed at providing an in-depth understanding of examples of embodiments of this description. The embodiments may be obtained without one or more of the specific details, or with other methods, components, materials, etc. In other cases, known structures, materials, or operations are not illustrated or described in detail so that certain aspects of embodiments will not be obscured.

Reference to “an embodiment” or “one embodiment” in the framework of the present description is intended to indicate that a particular configuration, structure, or characteristic described in relation to the embodiment is included in at least one embodiment. Hence, phrases such as “in an embodiment” or “in one embodiment” that may be present in one or more points of the present description do not necessarily refer to one and the same embodiment. Moreover, particular configurations, structures, or characteristics may be combined in any adequate way in one or more embodiments.

The headings/references used herein are provided merely for convenience and hence do not define the extent of protection or the scope of the embodiments.

Throughout the figures annexed herein, unless the context indicates otherwise, like parts or elements are indicated with like references/numerals and a corresponding description will not be repeated for the sake of brevity.

For the sake of simplicity and ease of explanation, a same designation may be applied throughout this description to designate:
a certain node or line as well as a signal occurring at that node or line (the supply line or node referred to in the following as VDD may be exemplary of this);
a certain component (such as a capacitor, resistor or inductor of coil) as well as electrical parameters thereof.

Also, when it is mentioned that an element is “connected to” or “coupled to” another element, it should be understood that still another element may be interposed therebetween, as well as that the element may be connected or coupled directly to another element.

On the contrary, when it is possibly mentioned that an element is “connected directly to” or “coupled directly to” another element, it should be understood that still another element is not interposed therebetween.

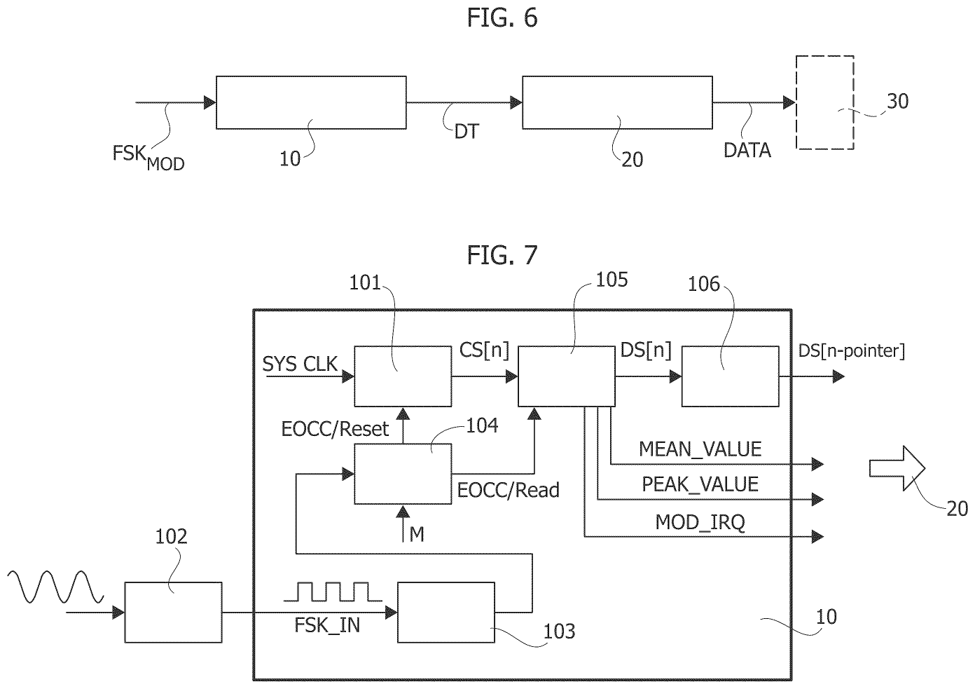

FIG. 6 is a block diagram illustrative of a possible context of use of solutions as described herein wherein an (RZ, NRZ, for instance) FSK-modulated signal encoded with an encoding scheme including inter-symbol and, possibly, intra-symbol level (frequency) transitions is applied to an FSK demodulator (FSKD) 10 to convert a frequency-keyed transmission signal FSKMOD into a digital signal DT (e.g. with a first frequency F1→“1” and a second frequency F2→“0”).

The demodulated signal DT obtained in response to demodulation is applied to a decoder 20 that converts the signal DT into actual data bits DATA for instance by converting a “01” or “10” sequence in the demodulated encoded signal (FIG. 2C) into a logic “1” in the decoded data signal (FIG. 2B) and converting a “11” or “00” sequence in the demodulated encoded signal (FIG. 2C) into a logic “0” in the decoded data signal (FIG. 2B).

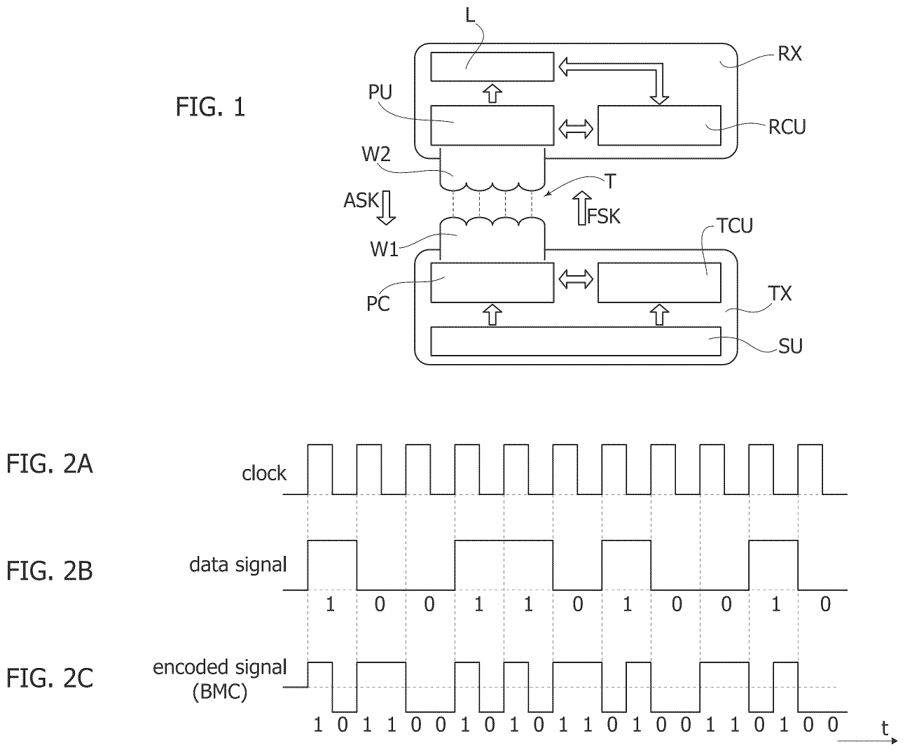

For simplicity and immediate reference, the blocks 10 and 20 of FIG. 6 may be regarded as included in the block RCU in the receiver RX of FIG. 1.

It is once more recalled that, in their more general aspects, solutions as described herein can be applied to various encoding schemes that include inter-symbol variations (that is, variations occurring between adjacent symbols) and, possibly, intra-symbol variations (that is, variations occurring between subsequent signaling elements within an individual symbol): reference to FSK modulation is thus primarily by way of example.

Reference to FSK modulation otherwise facilitates understanding advantageous aspects of solutions described herein that address certain issues likely to arise in connection with FSK modulation.

A demodulated encoded signal as represented in FIG. 2C can in fact be obtained from a modulated FSK signal (NRZ at frequencies F1 and F2, for instance) using a counter-based FSK demodulator 10 as illustrated in FIG. 7.

Such a demodulator 10 as represented in FIG. 7 receives:
a clock signal SYS_CLK (generated in a manner known per se to those of skill in the art) at a system clock counter 101, and
an FSK-modulated signal FSK_IN (for instance, from an associated zero-crossing analog-to-digital converter 102).

The signal FSK_IN (possibly filtered via a conditioning filter 103) is applied to a carrier cycle counter 104 configured to reset the system clock counter 101 via a signal EOCC/Reset (where EOCC refers to End Of Cycle Count) at every M cycles.

The zero-crossing analog-to-digital (A/D) converter 102 may include a rectifier which converts the input modulated wave (which may include half periods with positive polarity and half periods with negative polarity) into a positive polarity-only signal. Such rectified wave is then converted to digital data by means of comparators to produce the signal referred to as FSK_IN.

The (per se optional) filter module 103 may be provided to receive the FSK-modulated signal FSK_IN and clear it from possible glitches. A band-pass filter can be advantageously used for that purpose.

The output sampled from the system clock counter 101 is applied as a counter sample CS[n] to a processing (elaboration) block 105 configured to produce, in response to a read signal EOCC/Read from the carrier cycle counter 104:
a signal MEAN_VALUE indicative of the mean value of the samples in the signal CS[n] coming from the system clock counter 101;
a signal PEAK_VALUE indicative of the peak value of the signal CS[n] coming from the system clock counter 101;
a signal MOD_IRQ indicative of the presence of modulation in the modulated signal FSK_IN.

The processing block 105 is also configured to produce a signal DS[n] that is applied to a first-in first-out (FIFO) memory block 106 for use in generating a signal DS[n-pointer] as discussed in the following.

A counter-based approach implemented in a circuit as exemplified in FIG. 7 involves measuring a (generally unknown) frequency of the modulated signal FSK_IN based on the system clock frequency SYS_CLK (which is known).

By way of example (the values reported below are merely exemplary and non-limiting):
system frequency, SYS_CLK=48 MHz modulated frequency, FSK_IN_1:F1=127.772 kHz
clock “ticks” N1 (in one period at the frequency F1) N1=SYS_CLK/F1˜375.6, that is, 376+/−1 to account for sampling uncertainty modulated frequency FSK_IN_2:F2=126.984 kHz
clock “ticks” N2 (in one period at the frequency F2) N2=SYS_CLK/F2˜378.0, that is 378+/−1 to account for sampling uncertainty.

The values above are exemplary of a case where the frequencies F1 and F2 in the FSK signal (FSK_IN) can be very close to each other. Consequently, the difference in the clock ticks N1 and N2 counted in one period can be too small to facilitate a reliable detection of change in frequency: in a worst case, the difference in clock ticks in one period may even be (376+1)-(378-1)=0; for that reason, detection involves plural carrier cycles.

As illustrated in FIG. 7, the counter 104 is clocked by the (de-glitched) signal FSK_IN and is configured to undergo count increments (up-counts) at each rising edge of the signal FSK_IN, for instance.

By virtue of this mechanism, the counter module 104, can count consecutive detected carrier periods starting from the last RESET of the counter 104 and assert an internal signal EOCC/Reset when the count in the counter 104 reaches a value M (this may be a programmable parameter of the module) while simultaneously indicating that the module has counted a number M of consecutive full carrier cycles of the received signal FSK_IN.

Via the signal EOCC/Reset, the carrier cycle counter module 104 commands the reset of the system clock counter module 101.

Via the corresponding EOCC/Read signal, the carrier cycle counter module 104 causes the processing section module 105 to acquire the value of the count of the system clock counter module 101 before this is reset.

The EOCC/Reset signal may thus be (slightly) delayed with respect to the EOCC/Read signal to facilitate the acquisition of the value of the system clock counter 101 before reset thereof occurs. The internal signal EOCC/Reset also produces reset of the count in the carrier cycle counter 104: in that way the carrier cycle counter 104 becomes available for counting a subsequent set of M carrier cycles received.

The system clock counter 101 is clocked by the signal SYS_CLK and undergoes increments (up-counts) in an internal counter at each rising edge (for example) of the clock signal SYS_CLK starting from the last reset of the system clock counter. The (otherwise exemplary) values for N1 and N2 reported above indicate that the frequency of the clock signal SYS_CLK may be substantially higher than the carrier frequency/frequencies of the modulated signal FSK_IN.

The system clock counter 101 receives the signal EOCC/Reset from the carrier cycles counter 104. When the carrier cycles counter 104 reaches the (programmable) value M, it asserts the EOCC/Reset causing the reset of the system clock counter 101. Therefore, at that point the system clock counter 101 will have stored therein a value CS[n] which refers to a time interval equal to M cycles, expressed in terms of pulses of the signal SYS clk.

As such, the value CS[n] of system clock counter 101 depends on the frequency of the signal FSK_IN: the higher the frequency of the signal FSK_IN, the lower the value of the system clock counter 101; the lower the frequency of the signal FSK_IN, the higher the value of the system clock counter 101.

This mechanism facilitates converting an unknown FSK frequency into digital samples CS[n].

As noted, the digital values N1, N2 corresponding to two frequencies F1, F2 can be very close to each other and the evaluation is practically done over plural FSK carrier cycles (that is plural sets of M increments of the carrier cycles counter 104 with reset assertion of just the carrier cycles counter 104 once M is reached) instead of just 1.

The processing (elaboration) section 105 can be configured to even-out the samples CS[n] by averaging and to perform further sample evaluation: for instance, a base-line is extracted as the signal MEAN_VALUE along with a peak value signal PEAK_VALUE (based on the maximum variance around the mean value).

A modulation detection start signal MOD_IRQ can be used for decoding of the demodulated samples as discussed in the following.

The processing (elaboration) section 105 measures the average value (signal MEAN_VALUE) of the CS[n] sequence or a possibly filtered version thereof: in fact, the processing section 105 can optionally carry out filtering, for example of the moving average type, to remove unwanted noise from the sequence of demodulated samples DS[n] that is applied to the FIFO block 106.

The signals from the processing section 105 can be used for decoding of the demodulated samples DS[n] in various ways:
the signal MEAN_VALUE may provide a base-line that is continuously extracted to obtain a threshold useful in decoding NRZ/RZ symbols;
the signal PEAK_VALUE can be extracted continuously (through an iterative maximum point search, for instance) to obtain two other thresholds (+PEAK_VALUE) used to decode RZ symbols;
the signal MOD_IRQ may take the form of a pulse which is asserted when a transmission is detected, for instance in response to a variation larger than a programmable threshold occurring between the value of the current demodulated sample and a previous one.

The memory block 106 (FIFO, for instance) facilitates storing the demodulated samples DS[n] (demodulated signal DATA) that are then supplied as the signal DS[n-pointer] to the decoder 20 to be discussed in the following.

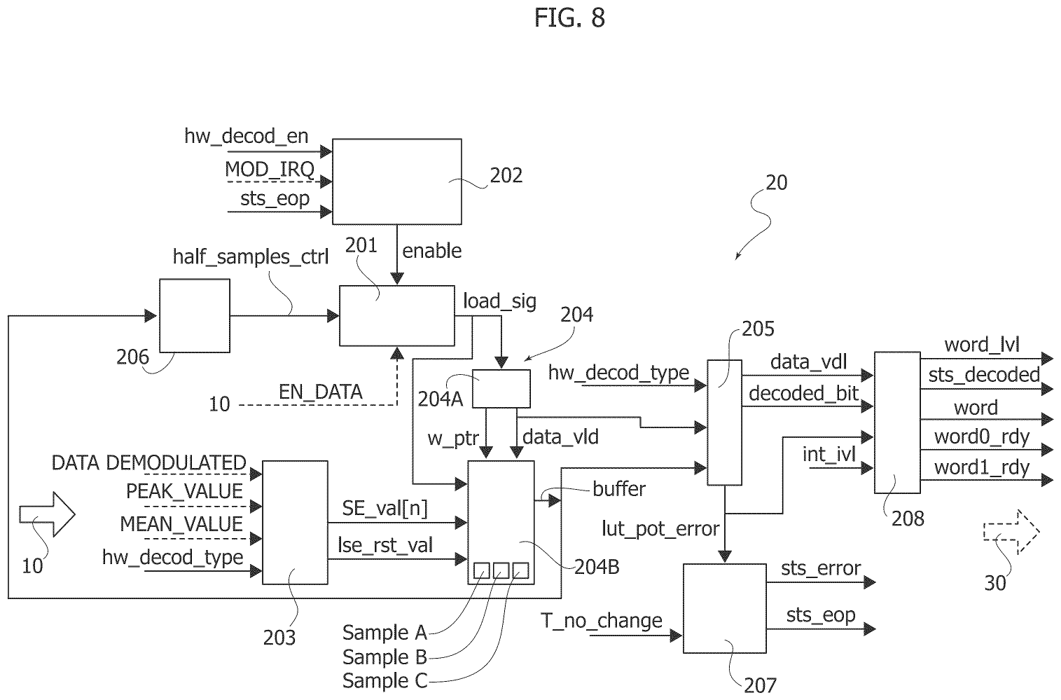

Irrespective of the implementation details, for the purposes herein both signals DS[n] and DS[n-pointer] can be regarded as exemplary of the signal labeled DATA_DEMODULATED in FIG. 8 (see also DT in FIG. 6).

The block diagram of FIG. 7 is thus exemplary of an approach where the frequency of the modulated signal FSK_IN is extracted by measuring the time duration of a cycle/period (or more cycles/periods) of the FSK signal, and where the duration is expressed in number of system clock SYS_CLK cycles. Therefore, SYS_CLK is counted during a cycle/period or plural cycles/periods of the FSK signal.

In fact, as discussed previously (with reference—merely by way of example—to a system frequency, SYS_CLK=48 MHz, and to modulated frequencies, FSK_IN_1:F1=127.772 kHz and FSK_IN_2:F2=126.984 kHz), the resulting clock “ticks” N1 may be ˜375.6, that is, 376+/−1 to account for sampling uncertainty and ˜378.0, that is 378+/−1 to account for sampling uncertainty. A more reliable estimate is obtained on multiple cycles/periods, for example M consecutive periods with M being a programmable value of the FSKD demodulator 10.

To summarize, the carrier cycle counter module 104 receives the modulated signal FSK_IN (possibly filtered at the block 103) as input and increases its count every time it identifies a (conventional) start of a carrier period, for example by increasing its count at each rising edge.

By virtue of this mechanism, the carrier cycle counter module 104 counts consecutive periods starting from the last reset of the module itself. In parallel, starting from the last reset, the system clock counter module 101 counts the number of consecutive cycles of its input clock SYS_CLK, for example by increasing its count at each rising edge of the signal SYS_CLK.

In addition, in response to the carrier cycle counter 104 reaching the count of M carrier cycles, the carrier cycle counter 104 issues the signal EOCC/Reset to produce reset of the system clock counter module 101 (if the FSKD demodulator 10 is configured such that CS[n] represents only a single window of M carrier cycles) while resetting at the same time its own count.

The latest value of the system clock counter 101 captured before reset will be indicative of the estimate of the FSK period measured on M consecutive periods, yielding a demodulated sample DS[n].

Structure and operation of a counter-based FSK demodulator 10 as described so far can be regarded as conventional in the art. A more detailed description will not be provided herein for brevity.

To summarize (by referring primarily to FIG. 6), the counter-based demodulator 10 discussed so far is exemplary of a demodulator configured to receive a modulated signal (a FSK modulated signal, FSK_IN, in the example considered here) and produce therefrom a sequence of samples DS[n] (DS[n-pointer]) of demodulated symbols DT wherein the demodulated symbols have level transitions between adjacent demodulated symbols and at least a part of the demodulated symbols have level transitions between adjacent signaling elements SE therein, wherein each measurement from the demodulator 10 provides a demodulated sample suited to be applied as demodulated data DT to a decoder 20.

Reciting the demodulated symbols as having level transitions between adjacent demodulated symbols wherein at least a part (at least some) of the demodulated symbols have level transitions between adjacent signaling elements therein is intended to highlight that, in the examples considered herein, an (inter-symbol) level transition is always present (in any case) between two subsequent demodulated symbols, but an (intra-symbol) level transition does not necessarily occur within each demodulated symbol: that is, not necessarily all symbols have level transitions between adjacent signaling elements SE therein.

That is, the demodulated symbols DT have (inter-symbol) level transitions between adjacent demodulated symbols and include demodulated symbols having (intra-symbol) level transitions between adjacent signaling elements SE therein, or, stated otherwise, the demodulated symbols DT have level transitions between adjacent demodulated symbols and—may have—level transitions between adjacent signaling elements SE therein.

In the case of NRZ, the demodulated symbols DT can be regarded as a set comprising a first subset (the symbols to be decoded as “0”, in the exemplary case illustrated in FIGS. 2B and 2C, for instance) and a second subset (the symbols to be decoded as “1”, in the exemplary case illustrated in FIGS. 2B and 2C, for instance); and (inter-symbol) level transitions always occur between two subsequent demodulated symbols in the whole set, while (intra-symbol) level transitions occur between adjacent signaling elements SE only for the symbols in the second subset (the symbols to be decoded as “1”, in the exemplary case illustrated in FIGS. 2B and 2C, for instance) and do not occur between adjacent signaling elements SE in the symbols in the first subset (the symbols to be decoded as “0”, in the exemplary case illustrated in FIGS. 2B and 2C, for instance), or vice-versa

In the case of RZ, intra-symbol transition is always present and the demodulated symbols DT can be regarded as a set wherein (intra-symbol) level transitions invariably occur also between adjacent signaling elements SE in the whole set of demodulated symbols namely both in the symbols of the first subset and in the symbols of the second subset.

To summarize: inter-symbol level transitions are always present both in RZ and NRZ; in the case of NRZ, intra-symbol transitions occur only for e.g. “1” bits, while in the case of RZ intra-symbol transitions are always present due to returning (always) to the rest frequency both for “1” bits and for “0” bits.

A decoder 20 as proposed herein may be a hardware (HW) decoder that is configured to receive the demodulated data samples DT coming from an FSK demodulator such as the counter-based demodulator 10 discussed previously and convert them into decoded packets DATA available for use by a user device 30 such as a CPU (with reduced effort on the user device 30 as a consequence).

A decoder 20 as described herein is compatible with NRZ (Non-Return-to-Zero) as well as with RZ (Return-to-Zero) custom protocols.

Encoding schemes where a decoder 20 as described herein can be advantageously used include differential bi-phase according to a Qi protocol encoding such as differential Manchester code (DMC) or biphase mark code (BMC).

It is otherwise once more remarked that referring herein to an FSK decoder compliant with a Qi protocol is merely by way of non-limiting example: aspects of the present description are not limited to that specific possible application.

A decoder 20 as described herein can decode incoming demodulated samples DT and detect errors in transmission (or errors due to poor calibration of a corresponding demodulator 10) while also detecting an EOP (End-Of-Packet) event referred to the physical layer of the communication channel (which is different than the EOP event of the transmission protocol).

A decoder 20 as described herein can generate an interrupt when an expected number of bits is decoded, an error occurs, or when the transmission ends.

The decoder 20 illustrated in FIG. 8 is built around a sample counter 201 enabled via a signal indicated as “enable” from a start/stop logic circuitry 202. Such start/stop logic circuitry 202 can be configured to start HW decoding in response to a first modulation being detected (for instance, in response to the signal MOD_IRQ) and to stop HW decoding in response to an End Of Packet event being detected (that is, in response to a signal sts_eop being asserted as discussed in the following).

Optionally, enabling the HW decoder can be made programmable by means of a signal hw_decod_en. This option can be advantageous in so far operation can be made more efficient. In fact, the signal labeled as hw_decode_en in FIG. 8 may result in the HW decoder being either disabled to pursue different decoding methods (e.g. FW-based) or enabled when increased efficiency is desired.

The sample counter 201 loads a signal load_sig into a buffer 204 (comprising a buffer handler 204A and a sample storage section 204B) that also receives a signal SE_val[n] from a comparator 203.

The comparator 203 in turn receives from the demodulator 10 the signals DATA DEMODULATED (DS[n-pointer]), MEAN_VALUE and PEAK_VALUE (see the previous discussion related to FIG. 7) along with a signal hw_decode_type (discussed in the following).

As illustrated in FIG. 8, the buffer 204 sends a signal indicated as data_vld and a signal indicated as buffer to a look-up table (LUT) 205 from which a decoded signal decoded_bit is provided to a word buffer 208 (implemented as a FIFO, for instance). The word buffer 208 can be read by a user device 30 as DATA (see FIG. 6) and can be managed as discussed in the following in connection with FIG. 13.

As illustrated in FIG. 8, the buffer 204 also sends the signal designated “buffer” towards a drift control block 206 that (by operating as discussed in the following in connection with FIGS. 14 to 18) returns to the sample counter 201 a signal indicated as half_samples_ctrl.

As illustrated in FIG. 8, the look-up table (LUT) 205 also receives the signal hw_decode_type applied to the comparator 203 and sends a signal indicated as lut_pot_error to an error/end of packet logic circuitry 207.

Solutions as proposed herein are primarily related to the decoder 20, being otherwise understood that: a demodulator such as the FSK demodulator (FSKD) 10 discussed previously in connection with FIG. 7 can be regarded as essentially conventional in the art; and while possibly included in a same system, the user device 30 does not per se represent a part of the embodiments disclosed herein: these embodiments are in fact largely “transparent” to the possible use of the decoded signal DATA in the user device 30.

Turning to a more detailed description of the exemplary embodiment illustrated in FIG. 8, the sample counter module 201 and the comparator 203 are configured to count the number of samples DS[n](DS[n-pointer]) acquired from the FSK demodulator (FSKD) 10 of FIG. 7.

To that effect, individual sample acquisition events are signaled to the sample counter 201 by signals on an input line to the sample counter module 201 labeled EN_DATA, which represents valid data (see also the line data_vld from the buffer handler block 204A in the buffer 204) associated with a sample.

It is noted that the signal EN_DATA coming from the FSKD demodulator 10 and the signal data_vld supplied to the LUT 205 from the buffer 204 are two different signals: the former signal is generated with a frequency of number_of_samples_per_bit*bitrate, while the latter signal is generated with a frequency dependent on the bitrate.

The sample counter module 201 can be configured to operate in parallel with the comparator 203 in counting a number of samples equal to those contained in a signaling element SE which is in turn half of the period of the symbol to be decoded.

The counter 201 counts the signal samples and the comparator 203 translates the incoming samples in levels (that is 0, 1, and rest, for instance) depending on the thresholds and the decoding type.

More specifically, the sample counter module 201 can be configured to count a number of samples equal to those contained within the period of a signaling element SE which is in turn half of the period of the symbol to be decoded, and the comparator 203 compares the incoming samples with a threshold MEAN_VALUE in an NRZ case or with two thresholds TH_LOW and TH_HIGH obtained starting from MEAN_VALUE and PEAK_VALUE in the case of RZ modulation.

For instance, the sample counter module 201 can be configured to start counting from 0 up to N/2-1 (where N is the number of DS[n] samples contained in a symbol period) as indicated by the signal half_samples_ctrl coming from the drift control block 206 (to be discussed in the following) and provide a signal load_sig in response to the sample counter module 201 value equaling a sampling point value (programmable between 0 and N/4-1 or 1 and N/4, for instance, based on a programming input not visible in the drawing for simplicity).

The sample counter module 201 is enabled via the enable line by the start/stop logic circuitry 202 to activate the counting procedure starting in response to the signal MOD_IRQ received at the circuitry 202 which indicates the start of the signal modulation. The sample counter module 201 is reset each time the count value therein reaches a maximum value indicated over the half_samples_ctrl line coming from the drift control block 206.

As illustrated in FIG. 8, the start/stop logic circuitry 202 also receives an enabling signal hw_decode_en.

The comparator 203 is configured to make a binary decision in the case of two-level modulation (BMC or NRZ modulation, for instance) or a ternary decision in the case of three-level modulation (RZ modulation, for instance) by comparing the input samples received from the demodulator 10 with the value MEAN_VALUE used as a reference threshold value (in the case of two-level modulation such as BMC or NRZ modulation, for instance). In the case of three-level modulation (RZ modulation, for instance) comparison can be performed with two thresholds TH_LOW and TH_HIGH obtained starting from the values MEAN_VALUE and PEAK_VALUE.

By way of example, in the case of two-level modulation (NRZ for instance), each demodulated data item can be higher than the value MEAN_VALUE in response to the FSK frequency being F2, and lower in response to the FSK frequency being F1.

Again, by way of example, in the case of three-level modulation (RZ for instance): the demodulated data item can be higher than a first threshold TH_HIGH=(MEAN VALUE+PEAK VALUE/2) in response to the FSK frequency being F1, the demodulated data item can be lower than a second threshold TH_LOW=(MEAN VALUE-PEAK VALUE/2) in response to the FSK frequency being F2, else, the FSK frequency is the “rest” frequency Frest.

To summarize, in the case of two-level modulation (NRZ for instance) the demodulator 10 is configured to produce a sequence of samples of demodulated symbols (DT in FIG. 6) having level transitions between a first level and a second level, and the comparator 203 in the decoder 20 is configured to produce the signal SE_val[n] in response to a comparison of samples from the sequence of samples of demodulated symbols DT reaching the sampling point value with a reference threshold MEAN_VALUE that is indicative of the average value of the samples.

Likewise to summarize, in the case of three-level modulation (RZ for instance) the demodulator 10 is configured to produce a sequence of samples of demodulated symbols DT having level transitions between a first level and a base level as well as between a second level and the base level, wherein the base level (corresponding to the “rest” frequency in the exemplary case of FSK modulation) lies between the first level and the second level, and the comparator 203 in the decoder 20 is configured to produce the signal SE_val[n] in response to a comparison of samples from the sequence of samples of demodulated symbols DT reaching the sampling point value with an upper reference threshold and a lower reference threshold based on the average value MEAN_VALUE and the peak value PEAK_VALUE of these samples.

Advantageously, the upper reference threshold, TH_HIGH, is the result of adding half the peak value (PEAK_VALUE) to the average value (MEAN_VALUE); and the lower reference threshold, TH_LOW, is the result of subtracting half the peak value PEAK_VALUE from the average value MEAN_VALUE.

Whatever the specific option adopted, the result of the comparison in the output sample is represented by a signal SE_val[n] (signaling element value, that is half symbol value) from the comparator 203. In fact, in the case considered here, a symbol corresponds to a bit and a bit thus results from two signaling elements SE (with variations possibly occurring between signaling elements within a single symbol).

The signal SE_val[n] will thus have one of two values in the case of two-level modulation such as NRZ or one of three values in the case of three-level modulation such as RZ, sampled at the same frequency as the input.

The signal hw_decod_type is a two-level signal (configuration bit) that can be used to distinguish between different types of encoding to be considered for decoding (to distinguish between RZ and NRZ encoding, for instance).

It will be appreciated that each signaling element, SE considered herein represents a part (a half) of a symbol of the demodulated transmission (input to the HW decoder 20) which differs from the individual bits of the decoded transmission (output from the HW decoder 20).

For example, as exemplified in FIGS. 2B and 2C, in differential bi-phase encoding (as is the case of Qi standard) each decoded bit derives from two signaling elements in a symbol: that is, “01” and “10” represent is while “00” and “11” represent 0s.

The buffer 204 exemplified in FIG. 8 thus advantageously includes the buffer handler module 204A as well as the buffer section 204B having a 3-sample depth that receives a signal lse_rst_val (as discussed in the following).

The buffer 204 is thus capable of storing three subsequent values out of the samples in the sequence SE_val[n] from the comparator 203.

These subsequent samples in a row may be named Sample A, Sample B, and Sample C.

Sample A is a value in the sequence of the stream of demodulated samples SE_val[n] indicative of the logic level of a first signaling element of the currently received symbol; for example, it can be the value of the sequence SE_val[n] sampled approximately midway (sampling point equal to N/4-1) the first signaling element of the symbol that is currently received.

Sample B is a value in the sequence of the stream of demodulated samples SE_val[n] indicative of the logic level of the second signaling element of the currently received symbol; for example, it can be the value of the sequence SE_val[n] sampled approximately midway (sampling point equal to N/4-1) the second signaling element of the symbol that is currently received.

Sample C is a value in the sequence of the stream of demodulated samples SE_val[n] indicative of the logic level of the second signaling element of the symbol preceding the symbol that is currently received; for example, it can be the value of the sequence SE_val[n] sampled approximately midway (sampling point equal to N/4-1) the second signaling element of the preceding symbol.

The three-sample depth buffer 204B is controlled by the sample counter 201 via the signal load_sig (generated by the sampling counter 201 when it is at the sampling point).

This indicates the time where the current sample SE_val[n] available at the input of the buffer 204 is a sample corresponding to one of the samples defined as Sample A, Sample B, and Sample C.

The buffer handler (sub) module 204A can be configured (in a manner known per se to those of skill in the art) to manage the buffer section 204B in order to facilitate storing triplets of values corresponding to the samples referred to as Sample A, Sample B, and Sample C in the foregoing (these represent the current bit/symbol plus the previous half symbol).

For instance, a possible management policy can be implemented using a pointer w_ptr that points to the current location of the buffer section 204B intended to store the current value of SE_val[n] representative of a sample such as Sample A, Sample B, or Sample C depending on the instant of reception.

The pointer w_ptr is incremented at each load_sig pulse, pointing to the current buffer location of the buffer section 204B which represents either Sample A or Sample B.

Once w_ptr reaches the location for Sample B, it asserts a data_valid signal for a next block (that is, the LUT 205), then moves the content of Sample B to Sample C and, finally, wraps back to the location of Sample A.

During an initial transient, a first triplet of samples A, B, C is composed in the buffer 204 for the first time (a first content for Sample C is pre-loaded through the signal lse_rst_val, depending on the type and polarity of the transmission).

With the exception of that initial transient, when the decoder 20 is fully operational, every two samples stored in sequence in the buffer section 204B, a signal of valid buffer content, data_vld will be generated for processing by the subsequent blocks (that is, the LUT 205).

Upon assertion of the data_vld signal from the buffer 204, the LUT module 205 acquires and processes the three values currently stored in the buffer 204.

This may occur based on a table such as Table I below.

This table refers to the exemplary case of NRZ encoding (a similar table can be obtained for a RZ encoding).

Based thereon, the LUT (look-up table) 205 can provide a value indicative of the presence of a potential transmission error; and a decoded value of the symbol currently received.

TABLE I
processing of samples in buffer 204
Elements SE in the current symbol
(Sample A and B respectively)

| NRZ LUT | 00 | 01 | 10 | 11 |
|---|---|---|---|---|
| Second element SE in the | X1 | X1 | 10 | 00 |
| previous symbol (Sample C) = 0 | | | | |
| Second element SE in the | 00 | 10 | X1 | X1 |
| previous symbol (Sample C) = 1 | | | | |

Comparing RZ and NRZ encoding facilitates explaining the role and operation of the LUT module 205 in producing binary decoded logical signals (decoded_bit) based on the result of the comparison for adjacent signaling elements (SE) in the demodulated symbols as performed in the comparator 203.

For example, in the case of NRZ modulation, the LUT 205 can include a table with eight possible “entries” each corresponding to one of the possible triplets of buffer values (that is 000, 001, 010, 011, 100, 101, 110, and 111) and two values for each entry.

A first value is indicative of the current demodulated symbol (encoded value) that is 1/0, or “don't care” (that is, potentially wrong information to be discarded) if the first value indicated a reception condition corresponding to a potential error.

A second value, that is 1/0, is indicative of the presence of a potential error in the demodulated sequence that leads to the assertion of a corresponding signal lut_pot_error towards the logic circuitry 207.

A potential error can be defined on the basis of the observation of the presence or absence of the “syndrome” associated with the encoding applied in transmission: for instance, this may be such as to always involve a logic level transition (high-to-low or low-to-high) between two subsequent adjacent symbols transmitted.

The LUT module 205 may thus be configured (in a manner known per se) to indicate the presence of a potential error whenever the three values present in the buffer 204 do not comply with that syndrome; for instance, in the case of bi-phase encoding: 000, 001, 110, and 111.

The error/end of packet logic circuitry 207 generates an end of packet signal sts_eop in response to a situation where no changes in signaling elements are detected over a certain (programmable) period T, as sensed via a signal T_no_change applied thereto: otherwise, the circuitry 207 generates an error signal sts_error in response to the signal lut_pot_error from the LUT 205.

The end of packet signal sts_eop identifies a condition in which the FSK frequency can be considered stable for a given period (T_no_change), indicating no transmission.

In fact, in a system as illustrated in FIG. 1, when a data packet to be transmitted is finished, the transmitter TX may move to a (fixed) operating frequency fOP, and, as a consequence, the receiver RX no longer observes frequency variations at the inter-symbol boundaries.

As a result, the LUT 205 will generate reports of potential errors on the line lut_pot_error.

The same type of signaling can also be generated by the LUT 205 in the presence of real demodulation errors.

The demodulator 20 illustrated herein is capable of resolving the ambiguity between demodulation error and end of packet.

In that respect, T_no_change can be regarded as an (integer) parameter which represents the number of confirmations following a first report of a potential error via the signal lut_potential_error.

A possible implementation of a corresponding discrimination procedure is the following.

In response to a first symbol decoded with potential error (lut_pot_error), if-over a number of subsequent and consecutive symbols equal to T_no change—the decoding of each of them is accompanied by lut_potential_error/no transition reported information, then the system will assert the signal sts_eop.

However, if counting is started due to a first potential error and within an evaluation window equal to T_no_change a symbol is subsequently received that is not indicated as affected by a potential error, this means that a change in the symbol boundaries has occurred so that the potential error signal from which the T_no_change counting started was actually indicative of an error and the logic 207 will correspondingly assert a signal sts_error.

A possible implementation of such an approach can be based on a counter started from a first potential error with a potential error possibly ascertained at every subsequent symbols.

If a potential error is found to be present, the counter is incremented, otherwise the counter is not incremented, and an error is generated in case the counter has not reached its limit count value. If that end point is reached (with potential errors received at every symbol over the time T_no_change), an end of packet signal sts_eop is generated for the physical layer of the transmission by logic 207.

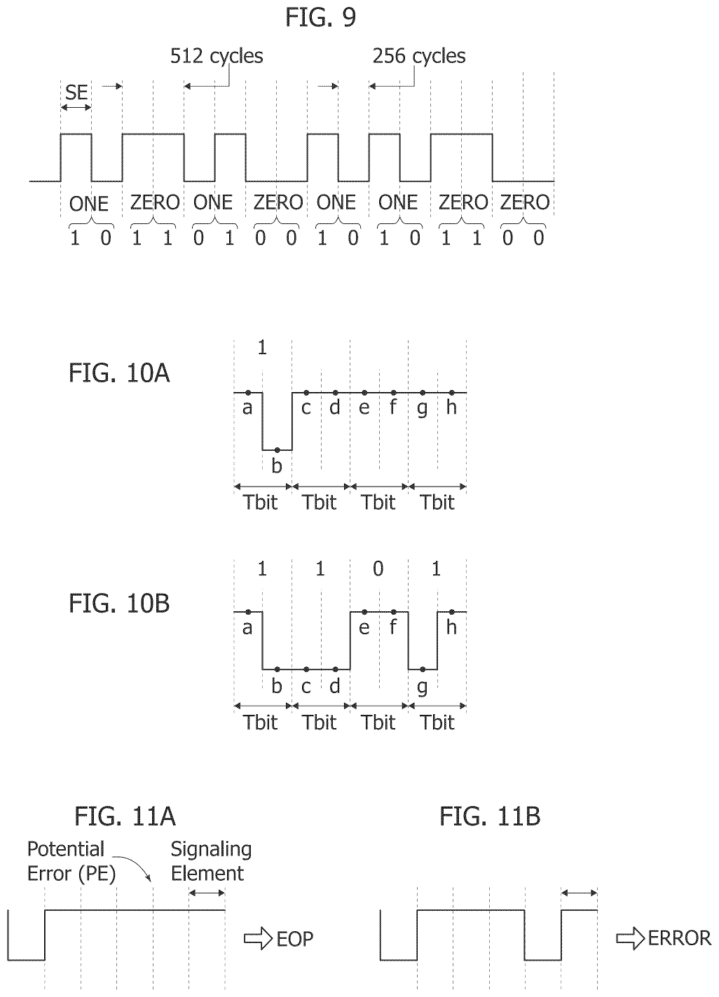

By way of summary and further possible explanation of the foregoing, FIG. 9 reproduces a possible time behavior of a demodulated signal (from the demodulator 10 of FIG. 7) including a sequence of symbols each having a duration of 512 clock cycles of a system clock signal (SYS_CLK in FIG. 7).

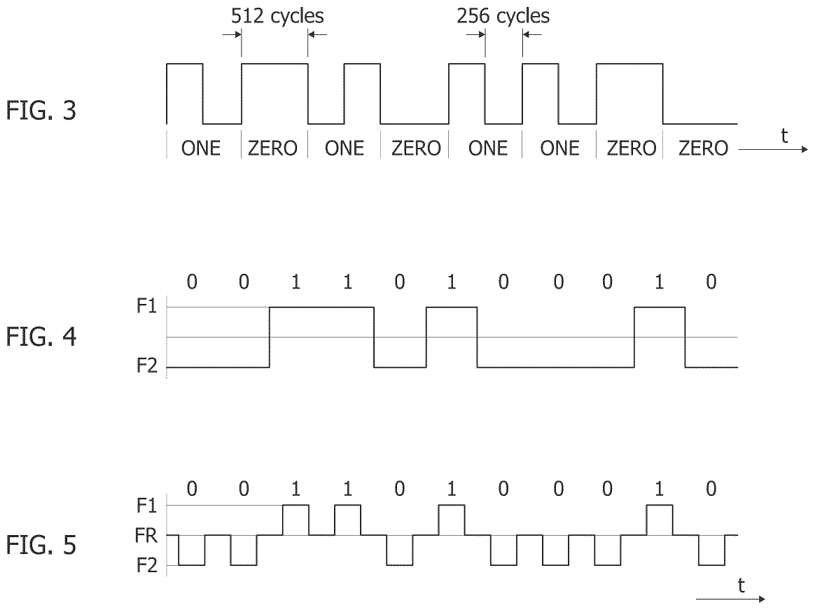

The demodulated signal of FIG. 9 is essentially the same exemplary demodulated signal of FIG. 3, where the following is highlighted:
i) each encoded symbol includes two signaling elements SE having equal duration of 512/2=256 clock cycles of the system clock signal;
ii) those symbols that include an intra-symbol transition (high-to-low or 1-to-0, or low-to-high or 0-to-1) between the two signaling elements SE therein are decoded as logical bits equal to ONE;
iii) those symbols that do not include any intra-symbol transitions between the two signaling elements SE therein (that is where the two elements SE are both high or low) are decoded as logical bits equal to ZERO;
iv) an inter-symbol transition (either low-to-high or high-to-low) occurs in any case between two subsequent adjacent encoded symbols.

Once again, the values indicated (512 cycles, 256 cycles) and the logical values (high, low, ONE, ZERO) are merely exemplary and non-limiting. For instance, a complementary decoding logic can be adopted wherein those symbols that include an intra-symbol transition between the two signaling elements SE therein are decoded as logical bits equal to ZERO and those symbols that do not include any intra-symbol transitions between the two signaling elements SE therein (that is where the two elements SE are both high or low) are decoded as logical bits equal to ONE.

FIG. 10A and FIG. 10B show possible sequences of values for signaling elements SE indicated as a, b, c, d, e, f, g, and h, where:
a, b correspond to a first demodulated symbol of duration Tbit;
c, d correspond to a second demodulated symbol of duration Tbit;
e, f correspond to a third demodulated symbol of duration Tbit;
g, h correspond to a fourth demodulated symbol of duration Tbit.

It is noted that neither of the sequences of FIG. 10A and FIG. 10B comply with the “syndrome” underlying points i) to iv) above.

In FIG. 10A, the sequence b,c,d does indeed comply with that syndrome (comparing the leftmost portion of FIGS. 9 and 10A shows this) but this is no longer the case for the sequence d,e,f (with no in-between transitions) and for the sequence f,g,h (again with no in-between transitions).

In these circumstances, the logic 207 might declare (based on the sequences previously stored in the buffer 204) either an error signal sts_error or an end of packet signal sts_eop.

However, since “no transitions” have been twice indicated (as a “persisting” condition), T_no change=1 facilitates the logic 207 in issuing an end-of-packet signal sts_eop.

In FIG. 10B, the sequence b,c,d (with no in-between transitions) does not comply with the encoding syndrome (comparing the leftmost portion of FIGS. 9 and 10B shows this) and in response to this the logic 207 might declare either an error signal sts_error or an end of packet signal sts_eop.

The sequence d,e,f shows however a transition so that “no-transitions” is indicated only once (the no-transition condition is not confirmed, and “isolated”) and this facilitates the logic 207 in issuing a demodulation error signal sts_error rather than an end-of-packet signal sts_eop.

Stated otherwise, in solutions as proposed herein the logic 207 is configured to generate:

an end-of-packet signal sts_eop in response to the signaling elements SE being received (demodulated) that do not change (no-transitions) over a-possibly programmable-time (as expressed by T_no_change), in a condition where the FSK frequency can be considered stable for a given period, indicating no transmission (this is exemplified in FIG. 11A); or an error signal sts_error, otherwise (this is exemplified in FIG. 11B).

False end-of-packet detection due to transmission errors can be countered as represented by Table II below.

TABLE II
End Of Packet v. Error detection

| Data stream | T_no_change | End Of Packet | Error |
|---|---|---|---|
| [ . . . ] 0 00 10 | 1 | 0 | 1 |
| [ . . . ] 0 00 11 | 1 | 0 | 1 |
| [ . . . ] 0 00 00 | 1 | 1 | 0 |
| [ . . . ] 0 00 10 00 | 2 | 0 | 1 |

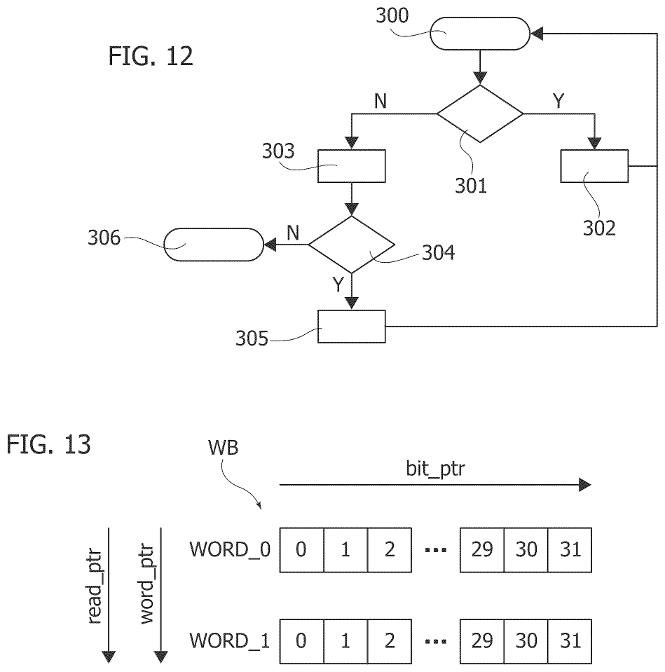

FIG. 12 is a flow-chart that further illustrates end-of-packet/error detection in solutions as described herein.

The blocks in the flow-chart of FIG. 12 are representative of the following steps or phases:
Block 300: on-going FSK transmission;
Block 301: check as to whether a variation (transition) has occurred between adjacent signaling elements SE (the last of the previous symbol and the first of the current one);
Block 302: potential error logic not triggered in response to a positive outcome (YES) of check in block 301; return to block 300;
Block 303: potential error logic triggered in response to a negative outcome (NO) of check in block 301;
Block 304: check as to whether a variation (transition) has occurred between adjacent signaling elements SE during a time interval as expressed by T_no_change;
Block 305: an error transmission notification sts_error (to FW for instance) in response to a positive outcome (YES) of the check in block 304, then return to block 300;
Block 306: end-of-packet signal sts_eop issued in response to negative outcome (NO) of check in block 304.

By way of summary, the blocks labeled 205 (LUT) and 207 in FIG. 8 can be regarded as exemplary of logic circuitry that is coupled to the buffer circuit 204 and is configured to detect (in step 301), based on the results of the comparison underlying decoding for at least three adjacent signaling elements for subsequent and consecutive symbols over a reference period of time (as represented by T_no_change), either one of:
an isolated absence of level transitions (inter-symbol and/or intra-symbol),
a persisting absence of level transitions (inter-symbol and/or intra-symbol).

The logic circuitry 205, 207 is thus configured (steps 303, 304 in the flow-chart of FIG. 12) to: assert (in step 305) an error-in-transmission signal sts_error in response to an isolated absence of the level transitions detected over the reference period of time T_no_change; or assert (in step 306) an end-of-transmission signal sts_eop in response to a persisting absence of the level transitions detected over the reference period of time T_no_change.

Advantageously, the buffer circuit 204 in the decoder 20 may be configured to have stored therein: a first result, previously referred to as Sample A, of comparison for a first signaling element SE of a currently received demodulated symbol; a second result, previously referred to as Sample B, of comparison for a second signaling element SE of the currently received demodulated symbol; and a third result, previously referred to as Sample C, of comparison for a second signaling element SE in the symbol preceding the currently received demodulated symbol.

The logic circuitry 205, 207 coupled to the buffer circuit 204 may thus be advantageously configured to detect the isolated absence or the persisting absence of level transitions (inter-symbol and/or intra-symbol) based on the first sample (Sample A), the second sample (Sample B), and the third sample (Sample C) stored in the buffer 204.

As noted, the sample counter 201 in the decoder 20 may be advantageously configured to sample the sequence DS[n] (DS[n-pointer]) of demodulated symbols DT in response to a count of the sample counter 201 reaching a sampling point (determined by the signal half_samples_ctrl) at least approximately halfway the adjacent signaling elements SE in the demodulated symbols DT.

FIG. 13 is a functional diagram illustrative of possible implementation details of solutions as described herein, wherein: a word buffer (WB) 208 is arranged cascaded to the LUT 205 (as illustrated in FIG. 8), and at each data_vld pulse indicating that a decoded bit is available, and in the absence of potential errors (lut_pot_error=0), a decoded_bit value is stored in the word buffer 208 (this buffer is referred to as word buffer in order to distinguish it from the buffer 204).

Exemplary outputs from the word buffer 208 (to be forwarded to the user device 30) may include the following signals:
word_lvl—number of decoded bits in the current pointed word,
sts_decoded—this signal raises when the desired number of bits is collected,
word—current pointed word,
word_0_rdy—If 1, the first word is available, and
word_1_rdy—if 1, the second word is available.

The depth (or length) of the word buffer 208 can be increased (WORD_0, WORD_1, . . . , WORD_K) as a function on the amount of data intended to be stored before each read event by the system firmware FW.

To that effect, a read pointer can be configured to toggle (only) in case of FW read after a word overflow.

Both HW and FW controls are facilitated in so far as a word pointer may change when a bit pointer overflow occurs.

Likewise, a bit pointer may be both FW- and HW-controlled. The bit pointer is reset to 0 in response to a read by FW, as well as in response to a bit pointer overflow.

A HW write can have priority with respect to a FW read if occurring at the same time, for data consistency.

Status bits may describe the status of the word buffer 208 with a programmable bit field used to trigger a possible interrupt in response to the word buffer exceeding a value associated therewith.

A decoder such as the decoder 20 of FIG. 8 includes a sampling counter 201 for sampling the demodulated transmission from a demodulator such as the demodulator 10 of FIG. 7 (it is noted that the demodulator 10 may by itself include other counters such as the system clock counter 101 and the carrier cycle counter 104).

In a context as exemplified herein, operating parameters may come into play that may lead to a forward or backward drift with respect to the (de) modulated data due to the integer representation of the expected FSK carrier cycles per sample.

For example (once more, the quantitative data reported below are merely exemplary and non-limiting) FSK transmission from a transmitter TX to a receiver RX as exemplified in FIG. 1 may involve the following parameters:
FSK carrier frequency Fc=127.772 kHz (FSK carrier frequency);
bitrate of the transmitted data=1 kbps (a bitrate is deliberately indicated here that is not compliant with the Qi standard in order to highlight the general nature of the solutions described herein);
number of carrier cycles per transmitted bit Ncpb_eff=Fc/bitrate=127.772;
number of samples N=16;
number of FSK carrier cycles per sample Ncps_eff=Ncpb_eff/N=127.772/16=7.9858.

The number of samples N referred to here is the number of times each demodulated symbol is sampled over its associated bit period (where bit period=1/bitrate, i.e. 1 ms in the present example), which is generally programmable and is assumed to be selected equal to 16 in the example considered herein.

As noted, having multiple sample points is advantageous in improving accuracy through post-processing (averaging, for instance).

A decoder such as the FSKD decoder 20 considered herein is inevitably programmed for acquiring an integer number of FSK (carrier) cycles (parameter M input to the block 104), which in the example considered can be rounded to 8 (closest integer ceiling of Ncps_eff=7.9858).

This leads to an accuracy error (drift) for each sample transmitted (8-7.9858=0.0142 cycle error in the case of the exemplary values reported above).

Solutions as described herein address that issue via the drift controller block 206 that is configured to:
determine “theoretical” errors (such as 0.0142, for instance) as detailed in the following,
accumulate these errors as a function of the transmitted bits and the type of encoding/decoding considered (NRZ or RZ, for instance, identified via the signal hw_decod_type), and
in response to the accumulated error (in absolute value) exceeding a (possibly programmable) threshold, vary the counting boundary (referred to as EOC distance) of the sampling counter 201 for the current signaling element SE and restore it for the next signaling element SE.

If the accumulated error is positive, the duration for the signaling element period SE is increased, otherwise it is reduced.

That variation can be made proportional to the ratio between the accumulated drift error and the number of FSK carrier cycles per sample (that is, M, and not necessarily just one, where M is the value already discussed of the boundary of the FCLK counter) to compensate plural errors (“multiples of the threshold”) in a single signaling element window (that is if M=8 and a threshold th=2*M is considered, the corrective action will be applied once there is a shift of two samples forward or backward, depending on the sign/direction).

The block diagram of FIG. 14 illustrates a possible implementation of a drift controller block 206 including three modules or sub-blocks 2061, 2062, and 2063.

For simplicity, FIG. 8 illustrates the signal labeled buffer from the buffer 204 as a single input signal to the drift control block 206. The more detailed representation of FIG. 14 highlights that the drift control block 206 is configured to generate the signal half_samples_ctrl by taking into account a set of signals that are not explicitly visible in FIG. 8.

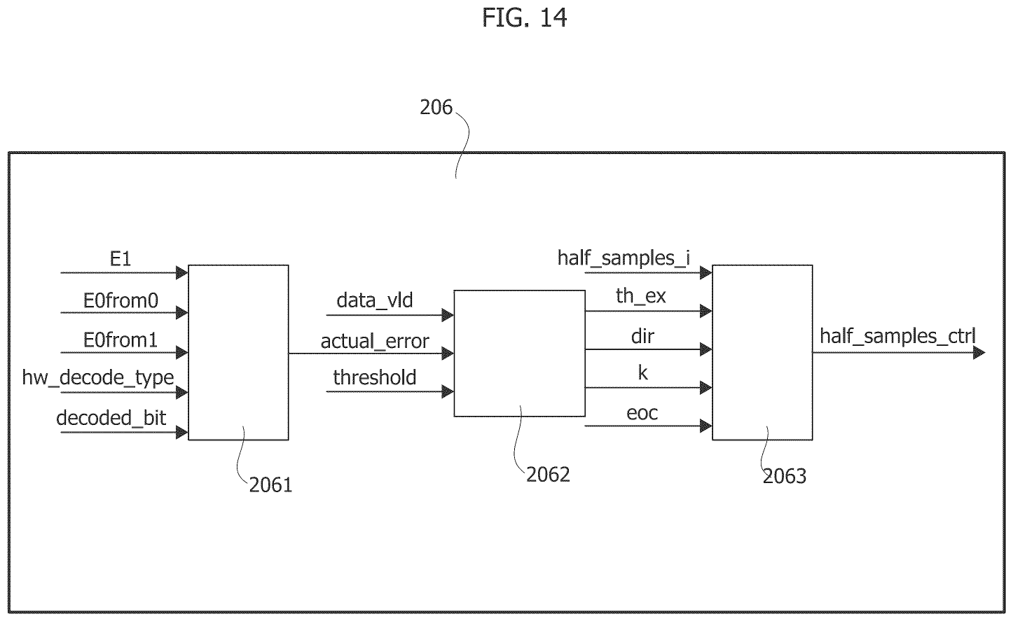

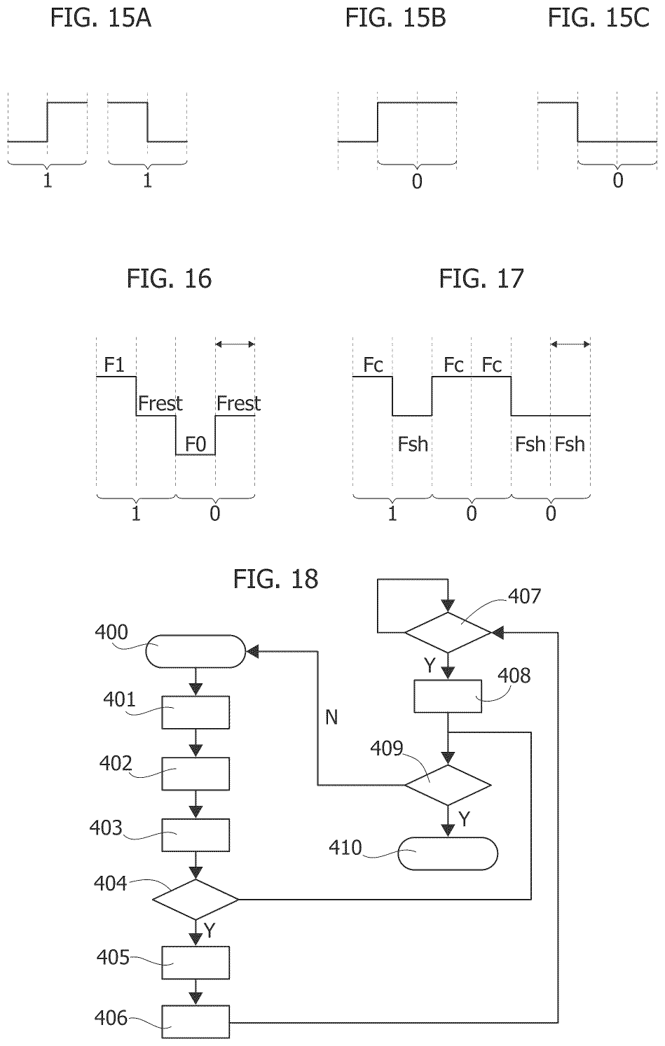

The module 2061 is an error selection module configured to receive as inputs pre-determined drift errors E1, E0from0, and E0from1 generated as exemplified in FIGS. 15A, 15B, and 15C.

As illustrated in FIG. 15A, E1 is a first (pre-determined) drift error component for a current decoded bit equal to 1 (for instance, this may be a demodulated symbol including an intra-symbol transition: this can be either low-to-high or high-to-low depending on the specific encoding adopted).

As illustrated in FIG. 15B, E0from0 is a second (pre-determined) drift error component for a previous (neighboring) decoded bit equal to 0 when the last signaling element SE of that previous symbol is 0.

As illustrated in FIG. 15C, E0from1 is a third (pre-determined) drift error component for a previous (neighboring) decoded bit equal to 0 when the last signaling element of that previous symbol is 1.

It is noted that in the case of RZ, the components E0from0 and E1from1 are equal and only two error components can be considered: E1 and E0from0 as E0.

That is:
in the case of NRZ, the definitions of E1, E0from0, and E0from1 given above fully apply; and
in the case of RZ, E0from0=E0from1=E0 since the second signaling element of the previous bit is always Rest, so that, contrary to the case of NRZ, there is no ambiguity.

The error selection module 2061 operates (as a function of the signal hw_decode_type, which may indicate NRZ or RZ, for instance) on the buffer signal from the buffer 204 in FIG. 8 to select adequate (theoretical) pre-determined error components, which may be E1, E0from0, and/or E0from1, based on the signal decoded_bit provided by the decoding logic (essentially the LUT 205) and the configured decoding type (signal hw_decod_type) and provides a signal actual_error that is indicative of the actual sampling error to the module 2062.

As shown, the module 2062 has also applied thereto the signal data_vld from the buffer 204 along with an (optionally programmable) drift threshold value, labelled simply as threshold and provides output signals th_ex, dir, and k.

In view of a proportional drift control action, the block 2062 provides, in addition to the signal th_ex indicative of when the drift control has to be applied, also a signal dir indicative of the direction of control (advance/delay) and a signal k indicative of the magnitude (size) of the control action.

At each pulse in the signal data_vld, generated by the decoding logic (LUT 205) when each decoded bit is available, the actual_error from the error selection block 2061 is accumulated (with sign). In response to (the absolute value of) the error thus accumulated exceeding the (programmable) threshold input thereto, the error accumulation block 2062 issues the signal th_ex, thus enabling the module 2063.

The module 2063 is configured to operate as a logic circuit that, in response to the signal th_ex, varies the position where the next signaling element SE is sampled by varying the current value half_samples_i (programmable field coming from registers) to a controlled value, namely half_samples_ctrl, using end-of-count signal eoc in order to time the update of the signal half_samples_ctrl.

Reference to “half” in the designations above is related to the fact that sampling the signaling elements midway through their duration is advantageous in so far as such a sampling point is a favorable sampling point distanced from both (logic level) transitions that may occur at the beginning and/or at the end of the signaling element SE.

Reference to “half” in the designations above is not however to be construed in a limiting sense as meaning that sampling the signaling elements SE should by way of necessity take place exactly midway their duration.

The EOC (end-of-count) control module 2063 of FIG. 14 can be configured in such a way that, when the signal th_ex rises, the end-of-count value eoc related to the input line value half_samples_i (intended to be used in the decoding logic) is increased/decreased (based on the signal dir) according to the sign of the error accumulated in the accumulator 2062, obtaining a new eoc value that is provided on the line half_samples_ctrl which is fed back to the decoding logic (the sampling counter 201).

Furthermore, the amount of such an increase/decrease is removed from the error accumulated in the accumulator 2062, thus possibly leaving a residual error therein. When the end-of-count value of the sampling counter 201 is reached, its value is restored to the pre-variation value (half_samples_i) for the next signaling element SE.

This possible way of operation is exemplified in FIG. 16 for a Return-to-Zero, RZ scenario and in FIG. 17 for a Non-Return-to-Zero, NRZ scenario (Qi-compliant Manchester NRZ, for instance).

To that effect, the figures primarily exemplify the concept underlying error computation via FW in the NRZ case (and for RZ too) for “0 from 0” and “0 from 1” rather than detailing system timing, that is how the blocks interact.

In the RZ case illustrated in FIG. 16, the drift error can be determined based on the following relationship:

$${E}_{1 / 0} = ( {F}_{1 / 0} / ( bitrate * {N}_{p o i n t s} ) - F C L {K}_{C N T} ) * {N}_{p o i n t s} / 2 + ( {F}_{r e s t} / ( bitrate * {N}_{points} ) - FCL {K}_{C N T} ) * {N}_{points} / 2$$

where the first term (F_{1/0}/(bitrate*Nₚₒᵢₙₜₛ)−FCLKCNT)*Nₚₒᵢₙₜₛ/2 indicates the shifted frequency error component (given by the difference between the actual number of cycles of the FSK shifted signal per sample and the programmed integer number of cycles of the FSK signal per sample) and the second term indicates the rest frequency error component (given by the difference between the actual number of cycles of the FSK carrier signal per sample and the programmed integer number of cycles of the FSK signal per sample).

As already noted, in RZ, the last signaling element in the previous bit (symbol) is always at Frest (the unmodulated FSK carrier frequency) so that E0from0=E0from1=E0.

In the NRZ case illustrated in FIG. 17, the drift error can be determined based on the following relationship:

$${E}_{1} = ( {F}_{C} / ( bitrate * {N}_{p o i n t s} ) - F C L {K}_{C N T} ) * {N}_{p o i n t s} / 2 + ( {F}_{s h} / ( bitrate * {N}_{p o i n t s} ) - F C L {K}_{C N T} ) * {N}_{points} / 2$$

$${E}_{ofrom 0} = ( {F}_{c} / ( bitrate * {N}_{p o i n t s} ) - F C L {K}_{C N T} ) * {N}_{p o i n t s}$$

$${E}_{ofrom 1} = ( {F}_{s h} / ( bitrate * {N}_{p o i n t s} ) - F C L {K}_{C N T} ) * {N}_{p o i n t s}$$

In both instances (FIG. 16 and FIG. 17):
FCLK_{CNT} represents the threshold, that is the programmed number of FSK carrier cycles per sample (FCLK_{CNT}=k*M where k & N; in case of immediate action, i.e. quickest possible drift correction, k=1 hence FCLK_{CNT}=M);
F_{1/0/rest/c/sh} is the input frequency
Nₚₒᵢₙₜₛ the number of samples per bit/symbol
Nₚₒᵢₙₜₛ/2 is the number of samples per signaling element SE (two such elements SE for each symbol/bit in the examples given herein).

To summarize, the end-of-count, EOC control module 2063 has the task of determining a “correct” maximum count value of the sample counter 201 as supplied to the counter 201 via the half_samples_ctrl line, in order to compensate the effect of drift that may occur in the demodulation process.

As exemplified herein, a correct value for the signal half_samples_ctrl is based:
i) on the value of the accumulated drift error obtained in the error accumulation module 2062, for example by indicating whether the value of the accumulated drift error has exceeded a given drift threshold, and
ii) on the nominal end value of the sample counter 201 module which—in the absence of drift—would correspond to N/2-1 (for consistency with the previous discussion), where N is the number of demodulated samples DS[n] generated in the demodulator 10 within the duration of a symbol (to be decoded into a bit), and provided through the line half_samples_i.

By way of simple example, if the accumulated drift error is expressed in number of carrier cycles, an adequate threshold may consist of an integer number equal to the integer closest to the number of carrier cycles contained in a sample (for example 8, if case the number of carrier cycles contained in a sample is Ncps_eff=Ncpb_eff/16=127.772/16=7.9858).

When the accumulated error (in absolute value) exceeds the value of the drift threshold (set at 8, for instance), the error accumulation module 2062 will assert the signal th_ex thus indicating that the count in the sample counter 201 is (at least) one sample late or in advance, depending on the sign of the accumulated error.

Determining an updated value of the signal half_samples_ctrl may involve subtracting or adding, for instance, a unity factor (one) or more from/to the value half_samples_i depending on the sign of the accumulated error and how the threshold is set (signal dir and k from the error accumulation block 2062 respectively).

The value for half_samples_ctrl thus determined can be used in the sample counter 201 to mitigate the effect of the drift phenomenon on the decoding process.

Concurrently with updating the value of half_samples_ctrl, the amount used for drift compensation can be removed from the value of the accumulated drift error in the block 2062: updating the value half_samples_ctrl in fact amounts to a step taken to compensate the very quantity for which the current accumulated error takes this compensation into account.

Once the sample counter 201 has reached the maximum count equal to the current value of half_samples_ctrl, the sample counter 201 can assert an end-of-count, eoc signal that is input to the control module 2063 and facilitates restoration of the value for half_samples_ctrl to the nominal maximum count value equal to half_samples_i

A programmable value of the drift threshold facilitates increasing that value (which can be a multiple of the minimum threshold th_min) in order to possibly postpone the compensation over multiple samples.

This facilitates adjusting the sensitivity/reactivity of the compensation mechanism: reducing the drift threshold value will lead to a more reactive compensation mechanism.

While exemplary of advantageous options, the specific values and formulas reported above do not represent imperative choices for implementing drift control as discussed herein based on general principles that can be summarized as follows.

The decoder 20 advantageously comprises sampling point drift correction circuitry 206 (see the blocks 2061, 2062, 2063 in FIG. 14) coupled to the buffer circuit 204 and configured to:
i) determine (via the block 2061) a sampling point error (signal labeled actual_error) based on the sampling point drift evaluated over the two signaling elements in the current decoded symbol;
ii) produce (via the block 2062) an accumulated sampling point error and compare it (in absolute value) with a drift reference threshold; and
iii) in response to the (absolute value of) the accumulated sampling point error reaching the drift reference threshold, vary (via the block 2063) the sampling counter 201 EOC value (by increasing or decreasing it via the signal half_samples_ctrl) for a signaling element SE of a currently received demodulated symbol.

Advantageously, the decoder 20 is configured to restore the sampling counter 201 EOC value for a signaling element SE subsequent to the signaling element SE for which the sampling point value was varied (via the signal half_samples_ctrl) in response to the accumulated sampling point error reaching the drift reference threshold.

It is noted that the counter of the EOC value rather than the sampling point is advantageously changed. The next sampling point is then changed indirectly by varying the current EOC, by advancing it (bringing it forward) or delaying (postponing) it.

Advantageously:
the sampling point error is accumulated (in the block 2062) with sign, that is, can be positive or negative;
the absolute value of the accumulated sampling point error is compared (in the block 2062) with the drift reference threshold; and
the sampling counter 201 EOC value is varied (via the signal half_samples_ctrl from the block 2063) for a signaling element SE of a currently received demodulated symbol by increasing it if the accumulated sampling point error is positive or by decreasing it if the accumulated sampling point error is negative.

Still advantageously:
the drift reference threshold is the integer nearest to the number of cycles per sample, and/or
the sampling point drift correction circuitry is configured (in the block 2063, for instance) to vary the sampling counter 201 EOC value (via the signal half_samples_ctrl) by a plural number of units, optionally as a function of the ratio of the accumulated sampling point error to a multiple number of cycles per sample, namely the ratio between the accumulated error and the threshold multiple. By way of example, if the number of carrier cycles per sample is 8 (as in the exemplary case considered herein) and the threshold is programmed to 16 instead, once the accumulated error exceeds the threshold (16.7>16, for instance) then a correction factor 2 is applied (16/8=2).

In the exemplary case considered here, the decoder 20 is configured to produce binary decoded signals DATA (see FIG. 6 for immediate reference) having first and second binary values (namely “1” and “0”) and each currently decoded binary signal DATA has a preceding neighboring binary decoded signal; this was previously produced by the LUT 205 in response to a (previous) demodulated symbol DT from the demodulator 10 that includes a final (second) signaling element SE with a first or a second logic level, namely “low” (or “0”) or “high” (or “1”).

In such an exemplary case, the drift correction circuitry 206 can be configured (in the block 2061, for instance) to determine the sampling point error (the signal designated actual_error) as represented in FIG. 15A, FIG. 15B, and FIG. 15C, and to accumulate (in the block 2062) combinations of:
a first sampling point error component E1 in response to (see FIG. 15A) a currently decoded binary signal having the first binary value (equal to 1, for instance);
a second sampling point error component E0from0 in response to (see FIG. 15B) the currently decoded binary signal having the second binary value (equal to 0, for instance) and the second signaling element SE in the previously demodulated (neighboring) symbol from the demodulator 10 (from which the neighboring binary decoded signal was previously produced via the LUT 205 having the first logic level (“low” or “0”, for instance); and
a third sampling point error component E0from in response to (see FIG. 15C) the currently decoded binary signal having the second binary value (equal to 0, for instance) and the second signaling element SE in the previously demodulated (neighboring) symbol from the demodulator 10 (from which the neighboring binary decoded signal was previously produced via the LUT 205) having the second logic level (“high” or “1”, for instance).

It is noted that (rather than being pre-computed via FW processing by means of a formula) the components referred to above are selected depending on the actual decoded bit and the last signaling element in the previously decoded neighboring bit. The actual error is then accumulated, and once the error exceeds (in absolute value) the threshold, the control action implemented via the signal half_samples_ctrl changes the EOC value of the sampling counter 201, thus varying the sampling point to compensate the drift.

By way of further explanation, the flow-chart of FIG. 18 is exemplary of a dynamic drift compensation procedure that can be implemented in the block or module 206, wherein, with ongoing FSK transmission:
in response to a symbol (bit) being demodulated, a drift error value is determined (selected depending on the specific FSK configuration used) and accumulated with a current total drift error (this is initialized to 0 at the beginning of each FSK transmission);
in response to (the absolute value of) the accumulated total drift error exceeding a programmable threshold, the end-of-count distance (EOC value) for a current signaling element SE in the sampling counter 201 is varied (increased or decreased, depending on the sign of the total accumulated drift error);
a residual (total) drift error is computed as an error amount equal to the difference between the current accumulated error and the threshold;
in response to the sampling counter 201 reaching its end-of-count (EOC) value, the EOC value of the sampling counter 201 to be used for the next adjacent signaling element SE is restored to its pre-variation value; and
the procedure loops until an end-of-packet (EOP) condition sts_eop is detected, which indicates the end of FSK transmission.

The blocks in the flow-chart of FIG. 18 are representative of the following steps or phases:
Block 400: on-going FSK transmission;
Block 401: symbol-to-bit decoding;
Block 402: drift error evaluated based on bit value;
Block 403: drift error accumulated with sign;
Block 404: total drift error (absolute value)>than threshold? If NO, loop towards block 409 (see below); if YES, proceed to block 405;
Block 405: the EOC distance of the sampling counter 201 varied (+/−) based on sign of total drift error (depending on threshold value too, making it proportional thereto) and parameter k;
Block 406: residual total drift error evaluated as total drift error+/−threshold k*FCLK_{CNT};
Block 407: end of count of sampling counter 201? If NO, loop back and wait for end of count. If YES, proceed to block 408;
Block 408: the EOC distance of the sampling counter 201 is restored to pre-variation value (that is, the variation applied in block 405);
Block 409: end of packet? If NO, loop back to block 400 and wait for end of packet sts_eop; if YES, proceed to block 410;
Block 410: end of transmission.

Without prejudice to the underlying principles, the details and embodiments may vary, even significantly, with respect to what has been described by way of example only, without departing from the extent of protection.

The extent of protection is determined by the annexed claims.

What is claimed is:

1. A decoder configured to have applied thereto a sequence of demodulated symbols having level transitions between adjacent demodulated symbols and at least part of the demodulated symbols having level transitions between adjacent signaling elements therein, wherein the decoder comprises:
a sample counter configured to sample the sequence of demodulated symbols in response to a count of the sample counter reaching a sampling point value;
a comparator coupled with the sample counter, wherein the comparator is configured to perform a comparison with at least one reference threshold of samples from the sequence of demodulated symbols sampled by the sample counter in response to the count of the sample counter reaching the sampling point value;
a buffer circuit configured to store results of the comparison for at least three adjacent signaling elements of the demodulated symbols; and
logic circuitry coupled to the buffer circuit and configured to:
detect, based on the results of the comparison for the at least three adjacent signaling elements for subsequent and consecutive demodulated symbols over a reference period of time, an isolated absence or a persisting absence of the level transitions; and
assert an error-in-transmission signal in response to the isolated absence of the level transitions detected over the reference period of time; or
assert an end-of-transmission signal in response to the persisting absence of the level transitions detected over the reference period of time.

2. The decoder of claim 1, wherein the logic circuitry comprises a look-up table configured to produce decoded binary signals based on the result of the comparison for the adjacent signaling elements in the demodulated symbols.

3. The decoder of claim 1, wherein:
the sequence of demodulated symbols has the level transitions between a first level and a second level; and
the comparator is configured to perform the comparison of the samples from the sequence of demodulated symbols with a reference threshold indicative of an average value of the samples.

4. The decoder of claim 1, wherein:
the sequence of demodulated symbols has the level transitions between a first level and a base level as well as between a second level and the base level, wherein the base level lies between the first level and the second level; and
the comparator is configured to perform the comparison of the samples from the sequence of demodulated symbols with an upper reference threshold and a lower reference threshold based on an average value and a peak value of the samples.

5. The decoder of claim 4, wherein:
the upper reference threshold is equal to the upper reference threshold, the result of adding half of the peak value to the average value; and
the lower reference threshold is equal to the lower reference threshold, the result of subtracting half of the peak value from the average value.

6. The decoder of claim 1, wherein the buffer circuit is configured to store:
a first result of a first comparison for a first signaling element of a currently received demodulated symbol;
a second result of a second comparison for a second signaling element of the currently received demodulated symbol; and
a third result of a third comparison for the second signaling element in a demodulated symbol preceding the currently received demodulated symbol;
wherein the logic circuitry is configured to detect the isolated absence or the persisting absence of level transitions, based on the first, second, and third results.

7. The decoder of claim 1, wherein the sample counter is configured to sample the sequence of demodulated symbols in response to a count of the sample counter reaching a sampling point at least approximately halfway adjacent signaling elements in the demodulated symbols.

8. A receiver, comprising:
a demodulator configured to:
receive a frequency shift keying (FSK) modulated signal modulated over an FSK carrier; and
produce, from the FSK modulated signal, a sequence of demodulated symbols having level transitions between adjacent demodulated symbols and at least part of the demodulated symbols having level transitions between adjacent signaling elements therein; and
a decoder coupled to the demodulator, and comprising:
a sample counter configured to sample the sequence of demodulated symbols in response to a count of the sample counter reaching a sampling point value;
a comparator coupled with the sample counter, wherein the comparator is configured to perform a comparison with at least one reference threshold of samples from the sequence of demodulated symbols sampled by the sample counter in response to the count of the sample counter reaching the sampling point value;
a buffer circuit configured to store results of the comparison for at least three adjacent signaling elements of the demodulated symbols; and
logic circuitry coupled to the buffer circuit and configured to:
detect, based on the results of the comparison for the at least three adjacent signaling elements for subsequent and consecutive demodulated symbols over a reference period of time, an isolated absence or a persisting absence of the level transitions; and
assert an error-in-transmission signal in response to the isolated absence of the level transitions detected over the reference period of time; or
assert an end-of-transmission signal in response to the persisting absence of the level transitions detected over the reference period of time.

9. The receiver of claim 8, wherein a sampling point drift occurs in the sequence of samples in response to the FSK signal having a non-integer number of cycles for each sample in the sequence of demodulated symbols, and the decoder comprises sampling point drift correction circuitry coupled to the buffer circuit and configured to:
i) determine a sampling point error for a current decoded logical signal produced based on the result of the comparison for the adjacent signaling elements in the demodulated symbols;
ii) accumulate the sampling point error and compare the accumulated sampling point error with a drift reference threshold; and
iii) in response to the accumulated sampling point error reaching the drift reference threshold, vary the sampling point value (EOC) of the sample counter.

10. The receiver of claim 9, wherein the sampling point drift correction circuitry in the decoder is configured to restore the EOC of the sample counter for a second signaling element subsequent to a first signaling element for which the EOC of the sample counter was varied in response to the accumulated sampling point error reaching the drift reference threshold.

11. The receiver of claim 9, wherein the sampling point drift correction circuitry in the decoder is configured to:
i) determine the sampling point error with sign, wherein the sampling point error is positive or negative;
ii) compare with the drift reference threshold an absolute value of the accumulated sampling point error; and
iii) in response to the absolute value of the accumulated sampling point error reaching the drift reference threshold, vary the sampling point value by changing the EOC of the sample counter, increasing the EOC in response to the accumulated sampling point error being positive or by decreasing the EOC in response to the accumulated sampling point error being negative.

12. The receiver of claim 9, wherein the sampling point drift correction circuitry is configured to vary the EOC of the sample counter by a plural number of units.

13. The receiver of claim 9, wherein the decoder is configured to produce decoded binary signals based on the result of the comparison for the adjacent signaling elements in the demodulated symbols, wherein each currently decoded binary signal has a neighboring decoded binary signal previously produced in response to a demodulated symbol from the demodulator including a final signaling element with a first or a second logic level, wherein the sampling point drift correction circuitry is configured to determine the sampling point error and to accumulate:
a first sampling point error component in response to a currently decoded binary signal having a first binary value;
a second sampling point error component in response to the currently decoded binary signal having a second binary value and a first final signaling element in the neighboring decoded binary signal having the first logic level; and
a third sampling point error component in response to the currently decoded binary signal having the second binary value and a second final signaling element in the neighboring decoded binary signal having the second logic level.

14. The receiver of claim 8, wherein the logic circuitry comprises a look-up table configured to produce decoded binary signals based on the result of the comparison for the adjacent signaling elements in the demodulated symbols.

15. The receiver of claim 8, wherein:
the sequence of demodulated symbols has the level transitions between a first level and a second level; and
the comparator is configured to perform the comparison of the samples from the sequence of demodulated symbols with a reference threshold indicative of an average value of the samples.

16. The receiver of claim 8, wherein:
the sequence of demodulated symbols has the level transitions between a first level and a base level as well as between a second level and the base level, wherein the base level lies between the first level and the second level; and
the comparator is configured to perform the comparison of the samples from the sequence of demodulated symbols with an upper reference threshold and a lower reference threshold based on an average value and a peak value of the samples.

17. The receiver of claim 8, wherein the buffer circuit is configured to store:
a first result of a first comparison for a first signaling element of a currently received demodulated symbol;
a second result of a second comparison for a second signaling element of the currently received demodulated symbol; and
a third result of a third comparison for the second signaling element in a demodulated symbol preceding the currently received demodulated symbol;
wherein the logic circuitry is configured to detect the isolated absence or the persisting absence of level transitions, based on the first, second, and third results.

18. A communication system comprising:
a transmitter configured to transmit a modulated signal wherein a carrier is modulated via modulation symbols having level transitions between adjacent modulation symbols and at least part of the modulation symbols having level transitions between adjacent signaling elements therein; and
a receiver, comprising:
a demodulator configured to:
receive the modulated signal; and
produce, from the modulated signal, a sequence of demodulated symbols having level transitions between adjacent demodulated symbols and at least part of the demodulated symbols having level transitions between adjacent signaling elements therein; and
a decoder coupled to the demodulator, and comprising:
a sample counter configured to sample the sequence of demodulated symbols in response to a count of the sample counter reaching a sampling point value;
a comparator coupled with the sample counter, wherein the comparator is configured to perform a comparison with at least one reference threshold of samples from the sequence of demodulated symbols sampled by the sample counter in response to the count of the sample counter reaching the sampling point value;
a buffer circuit configured to store results of the comparison for at least three adjacent signaling elements of the demodulated symbols; and
logic circuitry coupled to the buffer circuit and configured to:
detect, based on the results of the comparison for the at least three adjacent signaling elements for subsequent and consecutive demodulated symbols over a reference period of time, an isolated absence or a persisting absence of the level transitions; and
assert an error-in-transmission signal in response to the isolated absence of the level transitions detected over the reference period of time; or
assert an end-of-transmission signal in response to the persisting absence of the level transitions detected over the reference period of time.

19. The communication system of claim 18, wherein the transmitter is configured to transmit a frequency shift keying (FSK) modulated signal modulated over an FSK carrier, wherein the FSK carrier is modulated via the modulation symbols having level transitions between the adjacent modulation symbols and the at least part of the modulation symbols having level transitions between the adjacent modulation symbols.

20. The communication system of claim 18 wherein the transmitter and the receiver are inductively coupled to facilitate transmission of the modulated signal along with wireless electrical power transfer from the transmitter to the receiver.
